(19) United States
(12) Patent Application Publication
(10) Pub. No.: US 2022/0325188 A1
(43) Pub. Date: Oct. 13, 2022

(54) CRUDE OIL STABILIZATION

(71) Applicant: T.EN PROCESSS TECHNOLOGY, INC., Houston, TX (US)

(72) Inventors: Rajeev Nanda, Katy, TX (US); Praveen Kumar, Sugar Land, TX (US)

(21) Appl. No.: 17/229,469

(22) Filed: Apr. 13, 2021

(51) Int. Cl. C10G 7/02; B01D 17/04; B01D 19/00; B01D 3/14; B01D 3/34; B01D 3/06

(52) U.S. Cl. CPC C10G 7/02; B01D 17/044; B01D 19/0036; B01D 17/042; B01D 3/143; B01D 3/343; B01D 3/06

(57) ABSTRACT

A system for stabilizing a hydrocarbon feedstock includes a High Pressure Separation (HPS) unit in fluid communication with a feedstock inlet. The HPS unit includes an oil outlet. The system includes a heated Low Pressure (LP) separator unit downstream from and in fluid communication with the oil outlet of the HPS unit. The heated LP separator unit includes an oil outlet. The system includes a heat exchanger positioned between the HPS unit and the heated LP separator unit.

### BACKGROUND OF THE INVENTION

### 1. Field of the Invention

The embodiments disclosed herein relate to crude oil stabilization separation systems and processes. More particularly, the embodiments disclosed herein provide improved low carbon foot print stabilization systems and processing of crude oils including shale oil or tight oil, resulting in fewer separation stages and lowering of hydrocarbon dewpoint of vapors to the vapor recovery unit.

### 2. Description of Related Art

It is common commercial practice to produce a stabilized crude oil for storage in a stock oil storage tank at the wellhead by treating a mixed stream of crude oil and natural gas to obtain a stabilized liquid hydrocarbon stream and a gaseous stream. This stabilization is typically carried out in a stabilization unit. The treating step is also referred to as a stabilization process.

The stabilization process helps to make the crude liquid hydrocarbons more suitable for further processing or handling, such as safe storage and/or for shipment in tankers. The stabilization process is commonly a multistage gas-liquid separation process, designed to separate lighter hydrocarbons, and thereby reducing vapor pressure to meet a desired specification such as a Reid Vapor Pressure (RVP) which is commonly used to ensure that the crude oil from the stabilization unit is acceptable for storage and/or transportation by a sea-going vessel such as an oil tanker and usually is less than 10 psi (68.9 kPag). The stabilization process often takes place in areas where available space may be limited, the site may be remote and/or skilled labor may not be available for construction.

Exemplary prior art of separation systems for stabilizing conventional crude oils is shown in FIG. 1 and identified by numeral 10. In the system 10, hydrocarbon feedstock, called well fluid 11, is first subjected to a high-pressure (75 to 250 psig, 517 to 1723 kPag) separation in a High Pressure Separator (HPS) unit 2, in which a bulk of the water 17 and gas 13 is removed. The un-stabilized oil 15, still containing some gas, light hydrocarbons and some water is further directed to a heated medium pressure separator unit 4, called a Heater Treater, operating at a temperature between 100° F. and 140° F. (37.7° C. and 60° C.). The Heater Treater unit 4 typically operates at a pressure ranging from 20-50 psig (138-345 kPag) and facilitates the separation of water and light end hydrocarbons from oil. In this prior art, only a partial separation of light end hydrocarbons takes place at the vapor outlet 19 of the Heater Treater unit 4. To achieve the desired stabilization of oil and the desired RVP, other lower pressure separation stages, namely a Vapor Recovery Tower (VRT) unit 14 operating at 1-7 psig (7-48 kPag), and oil storage tanks unit 16 operating at about 0.1 psig (0.69 kPag) are typically required downstream from outlet 21. Hydrocarbon vapors 19 from the Heater Treater unit 4 and hydrocarbon vapors 27 from the VRT unit 14 are typically recovered in Vapor Recovery Units (VRU) 6 and/or 12 but hydrocarbon vapors 31 from the storage tanks unit 16 are typically released to atmosphere or flared. The stabilized oil 29, from storage tanks unit 16, is transported after flowrate measurement through a Lease Automatic Custody Transfer (LACT) unit 18.

In other systems, such as those described in U.S. Patent Publication No. 2020/0165528, which is incorporated by reference in its entirety, crude oil stabilization is achieved in two stages compared to three or more separator stages in previously known art. In this system, well fluid is first subjected to a High Pressure (HP) separation in which bulk of the water and gas is removed. The oil, still containing gas, light hydrocarbons and some water, after pressure letdown is directed to a heated Low Pressure (LP) separator. The heated LP separator operates at a pressure in the range 3-10 psig and use heat to facilitate the separation of water and light end hydrocarbons from oil to result in stabilized oil product which is sent through LACT unit to customers. Hydrocarbon vapor from heated LP separator are typically recovered in Vapor Recovery units (VRU).

Such conventional methods and systems have generally been considered satisfactory for their intended purpose. However, there is still a need in the art for more efficient and lower cost stabilization processes for crude oil including shale or tight oil. There also remains a need in the art for a stabilization system with a smaller footprint that is easier to be modularized for better feasibility at remote locations. Additional objects of the present invention will become apparent from the following summary and detailed discussion of preferred embodiments of this invention.

### SUMMARY OF THE INVENTION

A system for stabilizing a hydrocarbon feedstock includes a High Pressure Separation (HPS) unit in fluid communication with a feedstock inlet. The HPS unit includes an oil outlet. The system includes a heated Low Pressure (LP) Separator unit downstream from and in fluid communication with the oil outlet of the HPS unit. The heated LP separator unit includes an oil outlet. The system includes a heat exchanger positioned between the HPS unit and the heated LP separator unit.

In some embodiments, the heat exchanger includes a vapor outlet. The vapor outlet can be routed to at least one of a gas outlet line from the HPS unit or the heated LP separator unit. A vapor recovery unit (VRU) can be downstream from and in fluid communication with a gas product outlet of the heated LP separator unit to recover hydrocarbon vapor therefrom. A gas injection input can be between the gas product outlet of the heated LP separator unit and the VRU. The gas injection input can be in fluid communication with a gas outlet of the HPS unit.

In some embodiments, the heat exchanger operates at a pressure ranging from 3-10 psig. The heat exchanger can include a first heat exchanger circuit having an upstream side in fluid communication with the oil outlet of the heated LP separator unit and a downstream side in fluid communication with a Lease Automatic Custody Transfer (LACT) unit inlet. The heat exchanger can include a second heat exchanger circuit in thermal communication with the first heat exchanger circuit. The second heat exchanger circuit can include an upstream side in fluid communication with the oil outlet of the HPS unit and a downstream side in fluid communication with a heated LP separator inlet.

The heated LP separator unit can be configured to operate at a pressure less than 20 psig. The heated LP separator unit can be configured to operate at a pressure from 3 psig to 10 psig. The heated LP separator unit can be configured to operate at a temperature above 110° F. The heated LP separator unit can be configured to operate at a temperature ranging from 110° F. to 160° F. The oil outlet of the heated LP separator unit can be configured to discharge stabilized oil having a Reid Vapor Pressure (RVP) of less than 10 psi. The system can be a two-stage separation system. The HPS unit can be configured to operate at a pressure ranging from 75 psig to 250 psig.

In accordance with another aspect, a process for stabilizing a hydrocarbon feedstock includes delivering the hydrocarbon feedstock to a feedstock inlet of a High Pressure Separation (HPS) unit. The process includes pressurizing the hydrocarbon feedstock in the HPS unit to separate at least one of a gas product or a water product from the hydrocarbon feedstock to generate an un-stabilized oil portion of the hydrocarbon feedstock. The process includes discharging the un-stabilized oil portion of the hydrocarbon feedstock from an oil outlet of the HPS unit. The process includes delivering the un-stabilized oil portion of the hydrocarbon feedstock to a heat exchanger to generate a pre-heated un-stabilized oil portion of the hydrocarbon feedstock. The process includes delivering the pre-heated un-stabilized oil portion of the hydrocarbon feedstock to a heated Low Pressure (LP) separator unit downstream from the heat exchanger. The process includes heating the pre-heated un-stabilized oil portion of the hydrocarbon feedstock in the heated LP separator unit to separate at least one of a second gas product or a second water product from the pre-heated un-stabilized oil portion of the hydrocarbon feedstock to generate a stabilized oil portion of the hydrocarbon feedstock. The process includes discharging the stabilized oil portion of the hydrocarbon feedstock from an oil outlet of the heated LP separator unit.

The process can be limited to two stages of separation. In some embodiments, the process includes delivering hydrocarbon vapor from a vapor outlet of the heat exchanger to at least one of a gas outlet line from the HPS unit or the heated LP separator unit. The process can include delivering a fraction of the gas product from the HPS unit to an inlet line of a vapor recovery unit (VRU) downstream from and in fluid communication with a gas product outlet of the heated LP separator unit. The process can include transferring the stabilized oil portion of the hydrocarbon feedstock from an oil outlet of the heated LP separator unit through a first heat exchanger circuit and to a Lease Automatic Custody Transfer (LACT) unit inlet. The process can include delivering the un-stabilized oil portion of the hydrocarbon feedstock to a heat exchanger includes delivering the un-stabilized oil portion of the hydrocarbon feedstock through a second heat exchanger circuit of the heat exchanger in thermal communication with the first heat exchanger circuit. The second heat exchanger circuit can have an upstream side in fluid communication with the oil outlet of the HPS unit and a downstream side in fluid communication with a heated LP separator inlet.

The heated LP separator can operate at a pressure less than 20 psig. The heated LP separator unit can operate s at a pressure ranging from 3 psig to 10 psig. The heated LP separator unit can operate at a temperature above 110° F. The heated LP separator unit can operate at a temperature ranging from 110° F. to 160° F. The HPS can operate at a pressure ranging from 75 psig to 250 psig. The process can include discharging stabilized oil having a Reid Vapor Pressure (RVP) of less than 10 psi from the oil outlet of the heated LP separator.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a schematic representation of a traditional stabilization system that includes more than three stages of separation;

FIG. 2 is a schematic representation of an embodiment of a stabilization system constructed in accordance with the present disclosure that includes two-stages of separation, a heat exchanger between the two stages, and gas injection from the gas outlet line of the HPS unit to the gas outlet product outlet line of the heated LP separator unit; and

FIG. 3 is a schematic representation of another embodiment of a stabilization system constructed in accordance with the present disclosure that includes two-stages of separation, a heat exchanger between the two stages, and gas injection from the gas outlet line of the HPS unit to the gas outlet product outlet line of the heated LP separator unit.

### DETAILED DESCRIPTION OF THE PREFERRED EMBODIMENTS

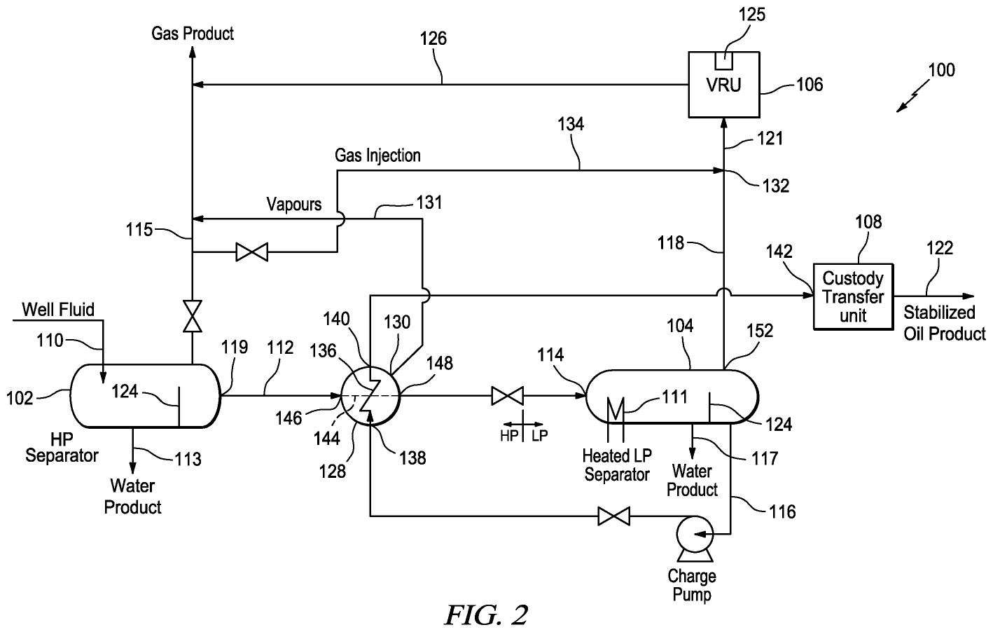

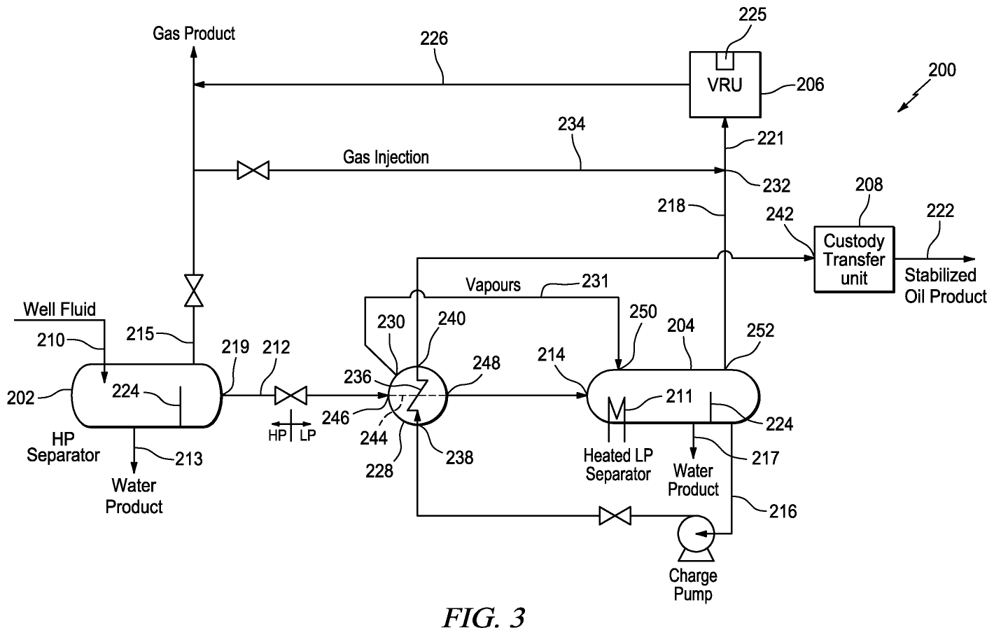

Reference will now be made to the drawings wherein like reference numerals identify similar structural features or aspects of the subject invention. For purposes of explanation and illustration, and not limitation, a schematic representation of an exemplary embodiment of a stabilization system in accordance with the invention is shown in FIG. 2 and is designated generally by reference character 100. Other embodiments of systems in accordance with the disclosure, or aspects thereof, are provided in FIG. 3 as will be described. The processes and systems of the invention can be used for more efficient stabilization of crude oil, including shale or tight oil, which results in reduced operating costs and smaller size. Specifically, the processes and systems of the present disclosure result in significant reduction in Green House Gas (GHG) emissions in crude oil stabilization by energy integration, e.g., via a heat exchanger, between two stages of separation. In addition, by injecting a small fraction of light gas from the HP separator the hydrocarbon dew point of the gas going to the VRU can be lowered, thus reducing condensation of hydrocarbons and thereby reducing compressor damage in the VRU, resulting in increased system reliability and further reducing GHG emissions.

As shown in FIG. 2, system 100 is a two-stage separation unit for stabilizing a hydrocarbon feedstock. System 100 includes a three-phase High Pressure Separation (HPS) unit 102, e.g., the first stage, in fluid communication with a feedstock inlet 110. The HPS typically operates at a temperature ranging from 40° F. (4° C.) to 140° F. (60° C.) and pressure of 75 to 250 psig (517 to 1723 kPag). The term “three-phase” as used throughout the description refers to a vessel capable of separating a gas phase, hydrocarbon phase and aqueous phase into dedicated outlets. Feedstock can be a well fluid, like crude oil, e.g., shale oil or tight oil, or the like. HPS unit 102 includes an oil outlet 119, e.g., an un-stabilized oil outlet 119 (hydrocarbon phase), a gas product outlet line 115 (gas phase), and a water product outlet 113 (aqueous phase). The separated gas that exits via the gas product outlet line 115 is the associated natural gas which comes along with crude oil and water from the oil wells. The bulk of this gas typically constitutes methane. HPS unit 102 is the first stage of separation that separates the incoming well fluid into a gas stream, un-stabilized oil stream 112 and water stream. In addition to gas product outlet, arrow 115 is used to schematically show the gas stream exiting HPS unit 102. In addition to water product outlet, arrow 113 is used to schematically show the water stream exiting HPS unit 102. Arrow 112 is used to schematically show the un-stabilized oil stream exiting HPS unit 102. The operating pressure of HPS unit 102 is governed by the gas stream destination pressure, which typically ranges from 75 to 250 psig (517 to 1723 kPag). The HPS unit 102 includes an internal weir plate 124 that segregates water and oil.

A heated Low Pressure (LP) Separator unit 104, e.g., the second stage, is a heated three-phase separator and is downstream from un-stabilized oil outlet 119 of HPS unit 102. The heated LP separator unit 104 includes an inlet 114, a heating input 111, a gas product outlet 152 (gas phase), a water product outlet 117 (aqueous phase), and an oil outlet 116, e.g., a stabilized oil outlet 116 (hydrocarbon phase). A gas stream 118 associated with the gas product outlet 152 is indicated schematically by the arrow 118 extending from heated LP separator unit 104. Water product outlet and the water product stream associated therewith are both indicated schematically by the arrow 117 extending from heated LP separator unit 104. Stabilized oil outlet and the stabilized oil stream associated therewith are both indicated schematically by the arrow 116 extending from heated LP separator unit 104. Inlet 114 is configured to receive the un-stabilized oil portion of the hydrocarbon feedstock that is discharged from HPS unit 102 via un-stabilized oil outlet 119. The heated LP separator unit 104 includes an internal weir plate 124 that segregates water and oil.

With continued reference to FIG. 2, system 100 includes a heat exchanger 128 positioned between the HPS unit 102 and the heated LP separator unit 104. In FIG. 2, the heat exchanger 128 is operated at high pressure. As such, the heat exchanger 128 includes a vapor outlet 130 routed via a vapor outlet line 131 to a gas product outlet line 115 from the HPS unit 102. The cold side of heat exchanger 128 operates at a pressure ranging from 75 to 250 psig (517 to 1723 kPag) and the hot side of the heat exchanger 128 typically operates at a pressure of 100 to 240 psig (690-1655 kPag). By having the heat exchanger 128 pre-heat the un-stabilized oil stream 112 prior to entering the inlet 114 of the heated LP separator unit 104 the heat duty of the heated LP separator unit 104 is reduced by 30-40% as compared with traditional two-stage systems, resulting in lower environmental emissions and operating cost. The pre-heating is done by heat transfer energy integration, e.g., the recovery of thermal energy from the product stream to pre-heat the feed stream, between hot stabilized oil product from the outlet 116 and cold un-stabilized oil product from HP Separator in heat-exchanger 128. The heat exchanger 128 includes a first heat exchanger circuit 136 having an upstream side 138 in fluid communication with the oil outlet 116 of the heated LP separator unit 104 and a downstream side 140 in fluid communication with a Lease Automatic Custody Transfer (LACT) unit 108 inlet 142. The heat exchanger 128 includes a second heat exchanger circuit 144 in thermal communication with the first heat exchanger circuit 136. The second heat exchanger circuit 144 includes an upstream side 146 in fluid communication with the oil outlet 119 of the HPS unit 102 and a downstream side 148 in fluid communication with a heated LP separator inlet 114.

Heat is applied by way of heating input 111 to separate the un-stabilized oil stream 112 from the HPS unit 102 into the stabilized oil stream 116, the water stream 117 and the vapor stream 118. Because of the heat duty reduction described above, system 100 allows for the potential to reduce cost and size of crude oil heater, e.g. heating input 111, and the associated equipment, including the size of the heated LP separator 104. Depending on the composition and characteristics of the un-stabilized oil in stream 112, the operating pressure and temperature in the heated LP separator unit 104 is controlled to boil off the lighter hydrocarbons from the un-stabilized oil in stream 112 to result in the stabilized oil of oil stream 116. A typical Heater Treater, e.g., heater treater 4, is provided by flue gases from a fired heater flowing directly through internal fire tubes. While heating in the heated LP separator 104 an internal heat exchanger using external heating medium. Lower heat energy is needed by use of internal heater because flashed gas and separated water portion is not heated in this scheme.

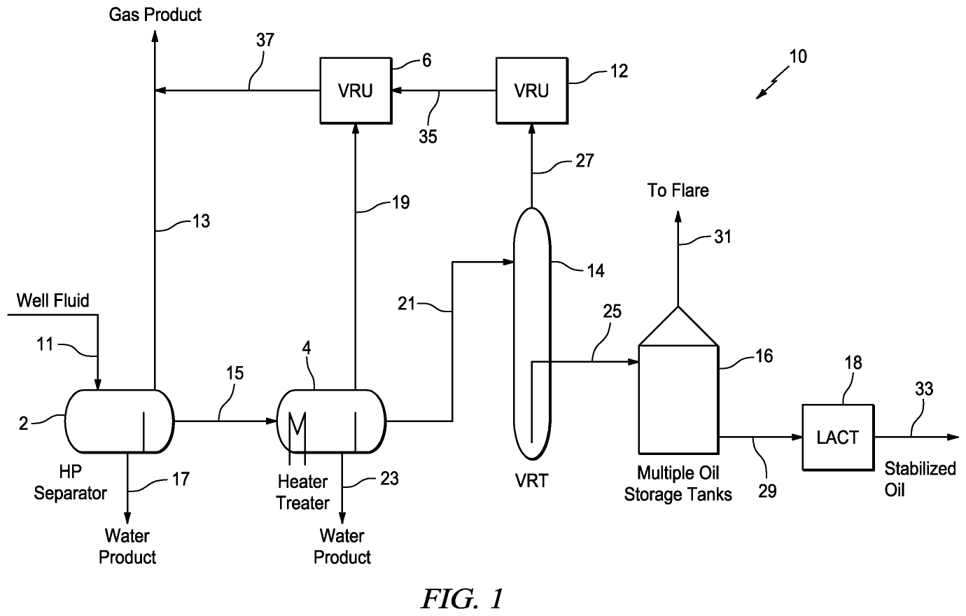

Heated LP separator unit 104 is configured to operate at a pressure less than 20 psig (137.9 kPag), for example, in some embodiments heated LP separator unit 104 operates at a pressure ranging from 3 to 10 psig (21 to 69 kPag). This is different from Heater Treater 4 (of FIG. 1) that typically operates at a pressure ranging from 20-50 psig (138-345 kPag). Heated LP separator unit 104 is configured to operate at a temperature above 110° F. (43.3° C.), for example above 125° F. (51.7° C.). For example, in accordance with some embodiments, heated LP separator unit 104 is configured to operate at a temperature ranging from 110° F. to 160° F. (43.3° C.-71.1° C.). More specifically, in some embodiments, the heated LP separator unit 104 is configured to operate at a temperature ranging from 125° F. to 151° F. (51.7° C. to 66.1° C.). This operating pressure and temperature results in stabilization of the crude oil being achieved in heated LP separator unit 104 itself without excessive additional heating and suits well for light crude oil (including shale or tight oil) stabilization. The lower operating pressure and heating, per thermodynamics, aids in an easy release of light hydrocarbons from the oil thus stabilizing the oil in heated LP separator unit 104, instead of requiring additional stages of separation to stabilize the oil, e.g., like those required in system 10 downstream from Heater Treater unit 4. This tends to provide benefits as there is less equipment required, thereby reducing installation and operating costs by approximately 20 percent. Additionally, less equipment means a smaller stabilization system and less required plot space compared to a traditionally designed facility. The equipment of the present embodiments can be easily put on modules which saves installation and start-up time and the modules can be moved to new locations.

Stabilized oil outlet 116 of heated LP separator unit 104 is configured to discharge stabilized oil that meets the desired specifications, e.g., in embodiments of the present disclosure, having a Reid Vapor Pressure (RVP) of less than 10 psi (68.9 kPa). RVP is a common measure of the volatility of crude oil and other petroleum products. It is defined as the absolute vapor pressure exerted by a liquid at 100° F. (37.8° C.) and is determined by the test method ASTM Standard D-323 or equivalent. The term “stabilized oil” or “stabilized oil portion” as used throughout this description means crude oil with a vapor pressure low enough to comply with transport and storage requirements, which is indicated by Reid Vapor Pressure (RVP) of less than 10 psi at 100° F. (37.78° C.). It will be readily appreciated by those skilled in the art that the requirements for stabilization may vary or can be based on other parameters.

As shown in FIG. 2, a vapor recovery unit (VRU) 106 is downstream from and in fluid communication with the gas product outlet 118 of heated LP separator unit 104 to recover hydrocarbon vapors from heated LP separator unit 104. A gas injection input 132 is between the gas product outlet 118 of the heated LP separator unit and the VRU 106. The gas injection input 132 is in fluid communication with a gas outlet line 115 of the HPS unit to receive a fraction 134 of the gas product from the HPS unit. The fraction, e.g. the fraction stream 134, is indicated schematically by the arrow 134 extending from gas product outlet line 115. The gas injection input 132 is fluidly connected to an inlet line 121 of the VRU 106. The VRU 106 contains a gas compressor 125 which increases the pressure of the vapors recovered from the heated LP separator unit 104. The gas injection input 132 of light gas from the HP separator unit 102 reduces the hydrocarbon dew point of the vapors exiting from the heated LP separator unit 104 without any significant impact on the VRU 106 power consumption. This low dew point gas to the VRU 106 prevents condensation of hydrocarbon and compressor damage in the VRU unit 106 thus increasing the plant uptime significantly, e.g. decreasing plant downtime, and reducing emissions. The high pressure discharge vapors 126 from the VRU combine with the gas product from the HPS and are routed to either a gas pipeline or a gas conditioning system.

As shown in FIG. 2, a Lease Automatic Custody Transfer (LACT) unit 108 is downstream from and in fluid communication with stabilized oil outlet 116. The LACT unit is provided for oil metering for custody transfer purposes. The LACT unit 108 receives the stabilized oil from stabilized oil outlet 116. From LACT unit 108, the stabilized oil can be discharged through a LACT outlet 122, after a flow rate measurement in the LACT unit 108, for safe storage or shipment. A LACT unit, like LACT unit 108, typically contains a flow meter, sampling system and provision of meter prover.

With continued reference to FIG. 2, when comparing FIG. 1 with FIG. 2, it is clear that the footprint of the oil stabilization process of FIG. 2 is much smaller than that of FIG. 1 in that system 100 of FIG. 2 does not include a second VRU, e.g., VRU 12, a VRT, e.g., VRT 14, or any oil storage tanks, e.g., oil storage tanks 16. Instead, in embodiments of the present invention, the fluid discharged from stabilized oil outlet 116 is already stabilized such that a VRT and oil storage tanks are not necessary. Heating the un-stabilized oil portion of the hydrocarbon feedstock in the heated LP separator unit includes heating the hydrocarbon feedstock to a temperature above 110° F. (43.3° C.). It is contemplated that heating the un-stabilized oil portion of the hydrocarbon feedstock in the heated LP separator unit includes heating the hydrocarbon feedstock to a temperature ranging from 110° F. to 160° F. (43.3° C.-71.1° C.).

With reference now to FIG. 3, another embodiment of a system 200 is shown. System 200 is the same as system 100 except that a heat exchanger 228 of system 200 operates at a low pressure and therefore includes a vapor outlet 230 routed via vapor outlet line 231 to an inlet 250 of a heated LP separator unit 204 instead of a gas product outlet line 215 of the HP separator unit 202. The cold side of heat exchanger 228 operates at a pressure ranging from 5-15 psig (34.5 to 103.4 kPag) and the hot side of heat exchanger 128 typically operates at a pressure of 100-240 psig (690-1655 kPag). System 200 is a two-stage separation unit for stabilizing a hydrocarbon feedstock. System 200 includes a three-phase High Pressure Separation (HPS) unit 202, e.g., the first stage, in fluid communication with a feedstock inlet 210. The HPS unit 202 is the same as HPS unit 102, described above. The feedstock can be a well fluid, like crude oil, e.g., shale oil or tight oil, or the like. HPS unit 202 includes an oil outlet 219, the same as outlet 119, a gas product outlet line 215, the same as outlet 115, and a water product outlet 213, the same as water product outlet 113. Arrow 212 is used to schematically show the un-stabilized oil stream exiting HPS unit 202. The operating pressure of HPS unit 202 is the same as that of HPS unit 102. The HPS unit 202 includes an internal weir plate 224 that segregates water and oil.

With continued reference to FIG. 3, the heated Low Pressure (LP) Separator unit 204 is the same as heated LP separator unit 104, except for the inlet 250, described above. The heat exchanger 228 is similar to heat exchanger 128 except for the operating pressure and the vapor routing, as described above. Heat exchanger 228 includes a first heat exchanger circuit 236 having an upstream side 238 in fluid communication with the oil outlet 216 of the heated LP separator unit 204 and a downstream side 240 in fluid communication with a Lease Automatic Custody Transfer (LACT) unit 208 inlet 242. The heated LP separator unit 204 includes an inlet 214, a heating input 211, a gas product outlet 218 (gas phase), a water product outlet 217 (aqueous phase), and an oil outlet 216, e.g., a stabilized oil outlet 216 (hydrocarbon phase). The gas stream 218 associated the gas product outlet 252 is indicated schematically by the arrow 218 extending from heated LP separator unit 204. Water product outlet and the water product stream associated therewith are both indicated schematically by the arrow 217 extending from heated LP separator unit 204. Stabilized oil outlet and the stabilized oil stream associated therewith are both indicated schematically by the arrow 216 extending from heated LP separator unit 204. Inlet 214 is configured the same as inlet 114. The heated LP separator unit 204 includes an internal weir plate 224 that segregates water and oil.

As shown in FIG. 3, heat exchanger 228 includes a second heat exchanger circuit 244 in thermal communication with the first heat exchanger circuit 236. The second heat exchanger circuit 244 includes an upstream side 246 in fluid communication with the oil outlet 219 of the HPS unit 202 and a downstream side 248 in fluid communication with a heated LP separator inlet 214. Heated LP separator unit 204 includes a heat input 211, which is the same as heat input 111. A vapor recovery unit (VRU) 206 is downstream from and in fluid communication with the gas product outlet 218 of heated LP separator unit 204 and is the same as VRU 106, described above. The high pressure discharge vapors 226 from the VRU combine with the gas product from the HPS and are routed to either a gas pipeline or a gas conditioning system.

With continued reference to FIG. 3, a gas injection input 232 is between the gas product outlet 218 of the heated LP separator unit 204 and the VRU 206. The gas injection input 232 is in fluid communication with a gas outlet line 215 of the HPS unit to receive a fraction 234 of the gas product from the HPS unit 102. The gas injection input 132 is fluidly connected to an inlet line 121 of the VRU 106. The fraction, e.g. the fraction stream 234, is indicated schematically by the arrow 234 extending from gas product outlet line 215. The VRU 206 contains a gas compressor 225, the same as gas compressor 125. The gas injection input 232 of light gas from the HP separator unit 202 reduces the hydrocarbon dew point of the vapors exiting from the heated LP separator unit 204 without any significant impact on the VRU 206 power consumption. This low dew point gas to the VRU 206 prevents condensation of hydrocarbon and compressor damage in the VRU unit 206 thus increasing the plant uptime significantly, e.g. decreasing plant downtime, and reducing emissions. A Lease Automatic Custody Transfer (LACT) unit 208 is downstream from and in fluid communication with stabilized oil outlet 216. The LACT unit 208 is the same as LACT unit 108. From LACT unit 208, the stabilized oil can be discharged through a LACT outlet 222, similar to LACT unit 108 described above.

A process for stabilizing a hydrocarbon feedstock includes delivering the hydrocarbon feedstock into a feedstock inlet, e.g., feedstock inlet 110 or 210, of a HPS unit, e.g., HPS unit 102 or 202, separating gas and water products from the hydrocarbon feedstock in the HPS unit to generate an un-stabilized oil portion of the hydrocarbon feedstock. Processing the hydrocarbon feedstock in the HPS unit includes maintaining a pressure ranging from 75 to 250 psig (517 to 1723 kPag) in the HPS unit. In some embodiments, this includes maintaining a pressure ranging from 125 to 200 psig (862 to 1379 kPag). The process includes discharging the un-stabilized oil portion of the hydrocarbon feedstock from an outlet, e.g., un-stabilized oil outlet 119 or 219, of the HPS unit. The process includes delivering the un-stabilized oil portion of the hydrocarbon feedstock to a heat exchanger, e.g., heat exchanger 128 or 228, to generate a pre-heated un-stabilized oil portion of the hydrocarbon feedstock.

The process includes delivering the pre-heated un-stabilized oil portion of the hydrocarbon feedstock into a heated LP separator unit, e.g., heated LP separator unit 104 or 204, downstream from the un-stabilized oil outlet of the HPS unit, heating the un-stabilized oil portion of the hydrocarbon feedstock in the heated LP separator unit to separate a second gas product, e.g., that indicated schematically by gas product outlet 118 or 218, and a second water product, e.g., that indicated schematically by second water product outlet 117 or 217, from the un-stabilized oil portion of the hydrocarbon feedstock to generate a stabilized portion of the hydrocarbon feedstock, and discharging the stabilized portion of the hydrocarbon feedstock from a stabilized oil outlet, e.g., stabilized oil outlet 116 or 216, of the heated LP separator unit. The process can include delivering a fraction, e.g. fraction 134 or 234, of the gas product from the HPS unit to an inlet line, e.g. inlet line 121 or 221, of a vapor recovery unit (VRU) downstream from and in fluid communication with a gas product outlet of the heated LP separator unit. In some embodiments, e.g., as shown in FIG. 2, the process includes delivering hydrocarbon vapor from a vapor outlet, e.g., vapor outlet 130, of the heat exchanger to a gas outlet line from the HPS unit, e.g., gas outlet line 115. In some embodiments, e.g. as shown in FIG. 3, the process includes delivering hydrocarbon vapor from a vapor outlet, e.g. vapor outlet 230, of the heat exchanger to the heated LP separator unit.

The process includes pressurizing the un-stabilized oil portion of the hydrocarbon feedstock in the heated LP separator unit by operating the heated LP separator unit at a pressure less than 20 psig (137.9 kPag). Some embodiments include pressurizing the un-stabilized oil portion of the hydrocarbon feedstock in the heated LP separator unit by maintaining a pressure ranging from 3 psig to 10 psig (21 to 69 kPag) in the heated LP separator unit.

The stabilized oil portion of the hydrocarbon feedstock that is discharged from the stabilized oil outlet of the heated LP separator unit has a Reid Vapor Pressure (RVP) of less than 10 psi (68.9 kPa). The process includes transferring the stabilized oil portion of the hydrocarbon feedstock from the stabilized oil outlet of the heated LP separator unit through a first heat exchanger circuit, e.g. first heat exchanger circuit 136 or 236, and to a Lease Automatic Custody Transfer (LACT) unit, e.g., LACT unit 108 or 208, downstream from and in fluid communication with the stabilized oil outlet. Delivering the un-stabilized oil portion of the hydrocarbon feedstock to a heat exchanger includes delivering the un-stabilized oil portion of the hydrocarbon feedstock through a second heat exchanger circuit, e.g. second heat exchanger circuit 144 or 244, of the heat exchanger. The second heat exchanger circuit is in thermal communication with the first heat exchanger circuit. The process includes discharging the gas product through a gas product outlet, e.g., gas product outlet 115 or 215, of the HPS unit, discharging the second gas product from a gas product outlet, e.g., gas product outlet 118 or gas product outlet 218, of the heated LP separator unit, and/or recovering the second gas product with a vapor recovery unit (VRU) downstream, e.g., VRU unit 106 or 206, from and in fluid communication with the gas product outlet of the heated LP separator unit. While the described system and process are described in the context of light feedstocks, e.g., shale oil or tight oil, the claimed process and system can process other suitable types of feedstocks as well.

Embodiments of the present disclosure provide for stabilization systems, methods and processes that have reduced heat duty, reduced downtime, and reduced GHG emissions as compared with other systems having two separation stages. The processes, methods and systems of the embodiments of the present disclosure, as described above and shown in the drawings, provide for stabilization systems with increased efficiency, reduced cost and smaller size. While the system, processes and methods of the subject invention have been shown and described with reference to preferred embodiments, those skilled in the art will readily appreciate that changes and/or modifications may be made thereto without departing from the spirit and scope of the subject invention. The above description and examples are merely illustrative of the invention and should not be construed as limiting the scope of the invention. Various modifications will become apparent to the skilled artisan in view of the foregoing disclosure. It is intended that all such modifications coming within the scope and spirit of the appended claims should be embraced thereby.

What is claimed is:

1. A system for stabilizing a hydrocarbon feedstock, the system comprising:
a High Pressure Separation (HPS) unit in fluid communication with a feedstock inlet, wherein the HPS unit includes an oil outlet;
a heated Low Pressure (LP) separator unit downstream from and in fluid communication with the oil outlet of the HPS unit, wherein the heated LP separator unit includes an oil outlet; and
a heat exchanger positioned between the HPS unit and the heated LP separator unit.

2. The system as recited in claim 1, wherein the heat exchanger operates at a pressure ranging from 3-10 psig.

3. The system as recited in claim 1, wherein the heat exchanger includes a vapor outlet, wherein the vapor outlet is routed to at least one of a gas outlet line from the HPS unit or the heated LP separator unit.

4. The system as recited in claim 1, further comprising a vapor recovery unit (VRU) downstream from and in fluid communication with a gas product outlet of the heated LP separator unit to recover hydrocarbon vapor therefrom.

5. The system as recited in claim 4, further comprising a gas injection input between the gas product outlet of the heated LP separator unit and the VRU.

6. The system as recited in claim 5, wherein the gas injection input is in fluid communication with a gas outlet of the HPS unit.

7. The system as recited in claim 1, wherein the heat exchanger includes a first heat exchanger circuit having an upstream side in fluid communication with the oil outlet of the heated LP separator unit and a downstream side in fluid communication with a Lease Automatic Custody Transfer (LACT) unit inlet.

8. The system as recited in claim 7, wherein the heat exchanger includes a second heat exchanger circuit in thermal communication with the first heat exchanger circuit, wherein the second heat exchanger circuit has an upstream side in fluid communication with the oil outlet of the HPS unit and a downstream side in fluid communication with a heated LP separator inlet.

9. The system as recited in claim 1, wherein the heated LP separator unit is configured to operate at a pressure less than 20 psig.

10. The system as recited in claim 1, wherein the heated LP separator unit is configured to operate at a pressure from 3 psig to 10 psig.

11. The system as recited in claim 1, wherein the heated LP separator unit is configured to operate at a temperature above 110° F.

12. The system as recited in claim 1, wherein the heated LP separator unit is configured to operate at a temperature ranging from 110° F. to 160° F.

13. The system as recited in claim 1, wherein the oil outlet of the heated LP separator unit is configured to discharge stabilized oil having a Reid Vapor Pressure (RVP) of less than 10 psi.

14. The system as recited in claim 1, wherein the system is a two-stage separation system.

15. The system as recited in claim 1, wherein the HPS unit is configured to operate at a pressure ranging from 75 psig to 250 psig.

16. A process for stabilizing a hydrocarbon feedstock comprising:
delivering the hydrocarbon feedstock to a feedstock inlet of a High Pressure Separation (HPS) unit;
pressurizing the hydrocarbon feedstock in the HPS unit to separate at least one of a gas product or a water product from the hydrocarbon feedstock to generate an un-stabilized oil portion of the hydrocarbon feedstock;
discharging the un-stabilized oil portion of the hydrocarbon feedstock from an oil outlet of the HPS unit;
delivering the un-stabilized oil portion of the hydrocarbon feedstock to a heat exchanger to generate a pre-heated un-stabilized oil portion of the hydrocarbon feedstock;
delivering the pre-heated un-stabilized oil portion of the hydrocarbon feedstock to a heated Low Pressure (LP) separator unit downstream from the heat exchanger;
heating the pre-heated un-stabilized oil portion of the hydrocarbon feedstock in the heated LP separator unit to separate at least one of a second gas product or a second water product from the pre-heated un-stabilized oil portion of the hydrocarbon feedstock to generate a stabilized oil portion of the hydrocarbon feedstock; and
discharging the stabilized oil portion of the hydrocarbon feedstock from an oil outlet of the heated LP separator unit.

17. The process of claim 16, wherein the process is limited to two stages of separation.

18. The process of claim 16, wherein the heat exchanger operates at a pressure ranging from 3-10 psig.

19. The process of claim 16, further comprising delivering hydrocarbon vapor from a vapor outlet of the heat exchanger to at least one of a gas outlet line from the HPS unit or the heated LP separator unit.

20. The process of claim 16, delivering a fraction of the gas product from the HPS unit to an inlet line of a vapor recovery unit (VRU) downstream from and in fluid communication with a gas product outlet of the heated LP separator unit.

21. The process of claim 16, further comprising transferring the stabilized oil portion of the hydrocarbon feedstock from an oil outlet of the heated LP separator unit through a first heat exchanger circuit and to a Lease Automatic Custody Transfer (LACT) unit inlet.

22. The process of claim 21, wherein delivering the un-stabilized oil portion of the hydrocarbon feedstock to a heat exchanger includes delivering the un-stabilized oil portion of the hydrocarbon feedstock through a second heat exchanger circuit of the heat exchanger in thermal communication with the first heat exchanger circuit, wherein the second heat exchanger circuit has an upstream side in fluid communication with the oil outlet of the HPS unit and a downstream side in fluid communication with a heated LP separator inlet.

23. The process of claim 16, wherein the heated LP separator operates at a pressure less than 20 psig.

24. The process of claim 16, wherein the heated LP separator unit operates at a pressure ranging from 3 psig to 10 psig.

25. The process of claim 16, wherein the heated LP separator unit operates at a temperature above 110° F.

26. The process of claim 16, wherein the heated LP separator unit operates at a temperature ranging from 110° F. to 160° F.

27. The process of claim 16, further comprising discharging stabilized oil having a Reid Vapor Pressure (RVP) of less than 10 psi from the oil outlet of the heated LP separator.

28. The process of claim 16, wherein the HPS operates at a pressure ranging from 75 psig to 250 psig.
